(19) United States
(12) Patent Application Publication
(10) Pub. No.: US 2008/0166122 A1
(43) Pub. Date: Jul. 10, 2008

(54) OPTICAL NETWORK BACKUP CHANNEL SWITCHING CONTROL DEVICE

(75) Inventor: Ching-Wen Hsiao, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC MULTIMEDIA & TELECOM CORPORATION, Taipei (TW)

(21) Appl. No.: 11/621,074

(22) Filed: Jan. 8, 2007

(51) Int. Cl. H04J 14/00

(52) U.S. Cl. 398/48

(57) ABSTRACT

An optical network backup channel switching control device is proposed, which is designed for use in conjunction with an optical network for providing a backup channel switching control function, and which is characterized by the capability of generating a main-channel monitoring beam and a backup-channel monitoring beam both on the local side and the remote side, where the main-channel monitoring beam is detected on the opposite side to determine whether the main channel is in good condition, and if a failure occurs to the main channel, the backup-channel monitoring beam is detected to determine whether the backup channel is in good condition. If the backup channel is in good condition, a switching action is then performed to switch the connection to the backup channel. This feature allows the optical network to have a higher level of reliability in operation.

### BACKGROUND OF THE INVENTION

1. Field of the Invention

This invention relates to optical networking technology, and more particularly, to an optical network backup channel switching control device which is designed for use in conjunction with an optical network of a single-line two-way transmission type for providing the optical network with a backup channel switching control function that can respond to an event of a failure to the main channel of the optical transmission line by switching the optical transmission path to a backup channel.

2. Description of Related Art

Optical networking is a communication technology for data transmission between computers, telephones and other electronic devices using laser beams transmitted through optical fibers. Optical networks can be used to transmit signals either in analog or digital forms. Since laser beams are much higher in frequency than electrical and radio signals, optical networking is far more reliable and has far greater transmission capacity than traditional cable and radio communications.

In a single-line two-way transmission type of optical network, a single strand of optical fiber is used for two-way transmission between the local optical data processing unit and the remote optical data processing unit. One problem to this type of optical network, however, is that data transmission can fail due to a breakup in the fiber or other reasons that cause an overly-low intensity in the signal beams. A solution to this problem is to provide two channels (i.e., two strands of fibers) in the optical transmission path: a main channel and a backup channel, where the main channel is initially set to active mode while the backup channel is set to backup mode, such that in the event of a failure to the main channel, the optical transmission path can be promptly switched to the backup channel. To achieve this purpose, there exists a need for a backup channel switching control device that is capable of switching to the backup channel in the event of a failure to the main channel.

### SUMMARY OF THE INVENTION

It is therefore an objective of this invention to provide an optical network backup channel switching control device which is capable of switching the optical network to the backup channel in the event of a failure to the main channel.

The optical network backup channel switching control device according to the invention is designed for use with an optical network of the type having a local optical data processing unit, a remote optical data processing unit, and an optical transmission line, where the optical transmission line is interconnected between the local optical data processing unit and the remote optical data processing unit and includes a main channel and a backup channel.

In architecture, the optical network backup channel switching control device according to the invention comprises: (i) a local switching control unit for interconnecting the local optical data processing unit with the optical transmission line; and (ii) a remote switching control unit for interconnecting the remote optical data processing unit with the optical transmission line; and wherein the local switching control unit and the remote switching control unit each include: (A) a monitoring beam generating module, which is capable of generating a main-channel monitoring beam and a backup-channel monitoring beam; (B) a main-channel multiplexing module, which is capable of injecting the main-channel monitoring beam generated by the monitoring beam generating module in a multiplexing manner into the main channel of the optical transmission line for transmitting the main-channel monitoring beam to opposite side; (C) a backup-channel multiplexing module, which is capable of injecting the backup-channel monitoring beam generated by the monitoring beam generating module in a multiplexing manner into the backup channel of the optical transmission line for transmitting the backup-channel monitoring beam to the opposite side; (D) a main-channel monitoring module, which is capable of monitoring whether the main channel of the optical transmission line can successfully transmit the main-channel monitoring beam from the opposite side; and if NOT, capable of generating a first switching enable signal; (E) a backup-channel monitoring module, which is capable of monitoring whether the backup channel of the optical transmission line can successfully transmit the backup-channel monitoring beam from the opposite side; and if NOT, capable of generating a second switching enable signal; and (F) a switching module, which is initially set to be connected to the main channel of the optical transmission line; and during actual operation, capable of responding to the first switching enable signal from the main-channel monitoring module and the second switching enable signal from the backup-channel monitoring module by switching the connection to the backup channel of the optical transmission line.

The optical network backup channel switching control device according to the invention is characterized by the capability of generating a main-channel monitoring beam and a backup-channel monitoring beam both on the local side and the remote side, where the main-channel monitoring beam is detected on the opposite side to determine whether the main channel is in good condition, and if a failure occurs to the main channel, the backup-channel monitoring beam is detected to determine whether the backup channel is in good condition. If the backup channel is in good condition, a switching action is then performed to switch the connection to the backup channel. This feature allows the optical network to have a higher level of reliability in operation.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the optical network backup channel switching control device of the invention with an optical network;

FIG. 2A is a schematic diagram showing the internal architecture of the local switching control unit utilized by the optical network backup channel switching control device of the invention; and

FIG. 2B is a schematic diagram showing the internal architecture of the remote switching control unit utilized by the optical network backup channel switching control device of the invention.

### DETAILED DESCRIPTION OF PREFERRED EMBODIMENTS

The optical network backup channel switching control device according to the invention is disclosed in full details by way of preferred embodiments in the following with reference to the accompanying drawings.

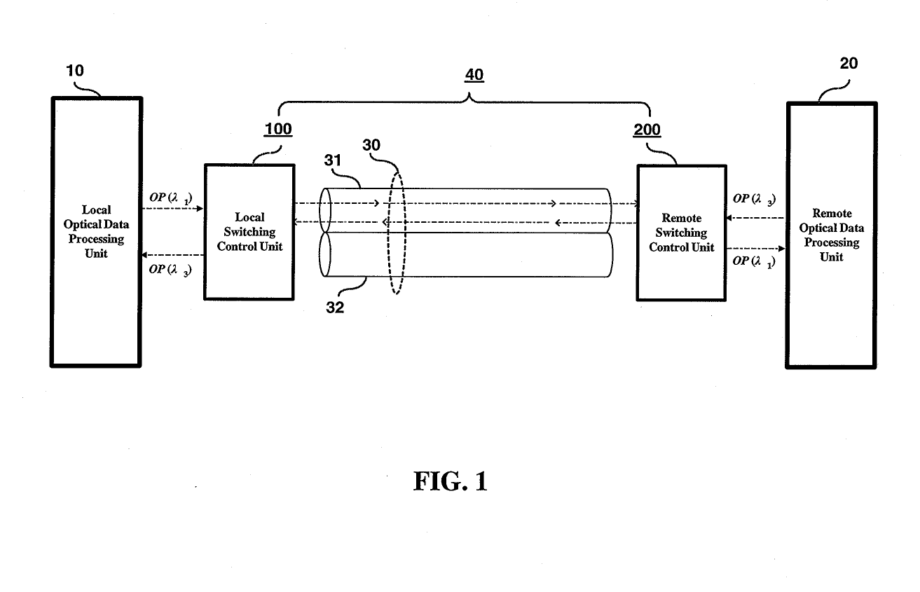

FIG. 1 is a schematic diagram showing the application of the optical network backup channel switching control device according to the invention 40. As shown, the optical network backup channel switching control device according to the invention 40 is based on a distributed architecture which is composed of two separate units: a local switching control unit 100 and a remote switching control unit 200, and which is designed for integration to an optical network system, such as a PON (Passive Optical Network) system, that is equipped with a local optical data processing unit 10, a remote optical data processing unit 20, and an optical transmission line 30. The optical transmission line 30 is interconnected between the local optical data processing unit 10 and the remote optical data processing unit 20 and includes a main channel 31 and a backup channel 32. In practical implementation, the optical transmission line 30 can be realized by using two optical fibers stranded together into a single line, one of which servers as the main channel 31 and the other serves as the backup channel 32. In PON application, for example, the local optical data processing unit 10 is an optical line terminal (OLT), while the remote optical data processing unit 20 is an optical network unit (ONU).

In actual operation, the local optical data processing unit 10 and the remote optical data processing unit 20 can transmit signal beams to and from the other via the optical transmission line 30 for data communication. The local optical data processing unit 10 is capable of emitting a signal beam OP(λ₁) having a wavelength of λ₁; and the remote optical data processing unit 20 is capable of emitting a signal beam OP(λ₃) having a wavelength of λ₃. Initially, the optical network backup channel switching control device according to the invention 40 is set to connect both the local optical data processing unit 10 and the remote optical data processing unit 20 to the main channel 31 of the optical transmission line 30, such that the signal beams OP(λ₁) and OP(λ₃) will be transmitted through the main channel 31; and in the event of a failure to the main channel 31, the optical network backup channel switching control device according to the invention 40 will switch the connection to the backup channel 32, such that the local optical data processing unit 10 and the local optical data processing unit 10 can nevertheless utilize the backup channel 32 for transmitting the signal beams OP(λ₁) and OP(λ₃).

It is to be noted that in the terminology of this specification, the term “local side” and “remote side” are used to distinguish the two optical data processing units 10, 20 installed on both sides of the optical transmission line 30, and which are interchangeable in the naming, i.e., the local optical data processing unit 10 can also be referred to as a remote unit while the remote optical data processing unit 20 is referred to as a local unit. Moreover, the term “opposite side” will be used to refer the opposite side of either side, i.e., the remote side is the opposite side of the local side, and the local side is the opposite side of the remote side.

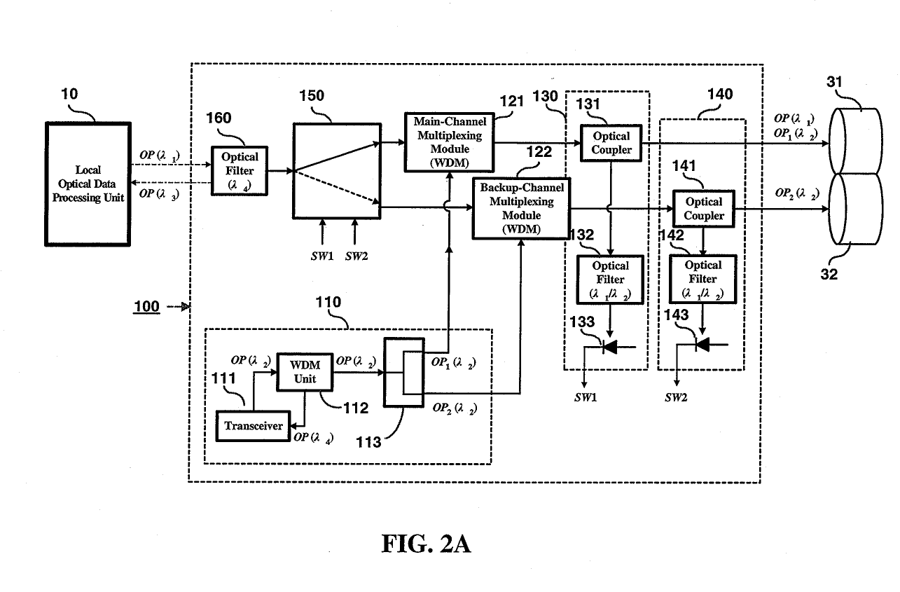

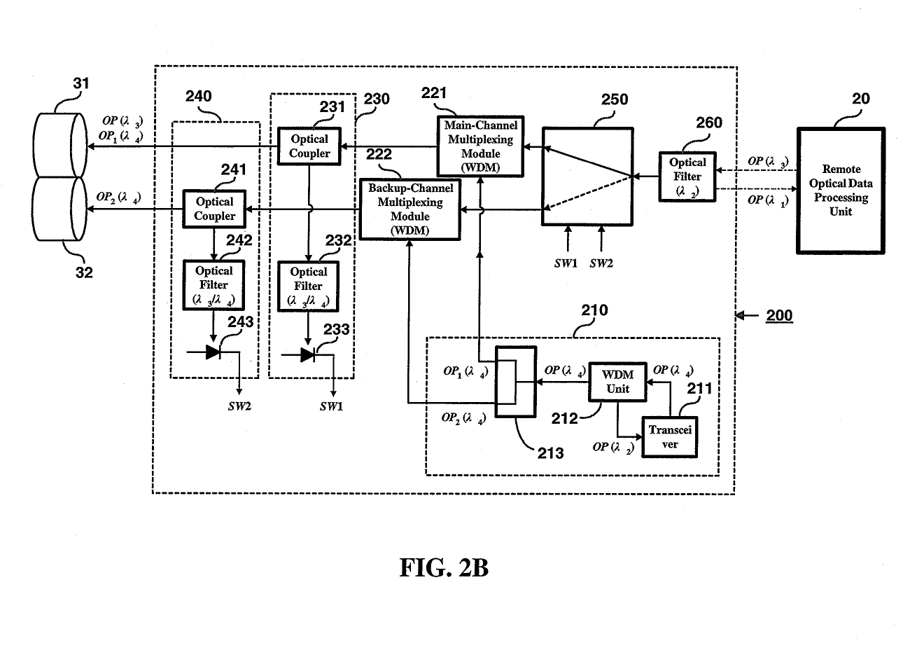

As shown in FIG. 1, the optical network backup channel switching control device according to the invention 40 is based on a distributed architecture comprising 2 separate units: (i) a local switching control unit 100; and (ii) a remote switching control unit 200; wherein the local switching control unit 100 is used for interconnecting the local optical data processing unit 10 with one end of the optical transmission line 30, while the remote switching control unit 200 is used for interconnecting the remote optical data processing unit 20 with the other end of the optical transmission line 30. Further, as shown in FIG. 2A and FIG. 2B, the local switching control unit 100 and the remote switching control unit 200 can be identical in internal architecture, each including: (A) a monitoring beam generating module 110, 210; (B) a main-channel multiplexing module 121, 221; (C) a backup-channel multiplexing module 122, 222; (D) a main-channel monitoring module 130, 230; (E) a backup-channel monitoring module 140, 240; and (F) a switching module 150, 250. Firstly, the respective attributes and behaviors of these constituent components are described in details in the following.

The monitoring beam generating module 110, 210 are used respectively on the local side and the remote side to generate a main-channel monitoring beam and a backup-channel monitoring beam. More specifically, the monitoring beam generating module 110 on the local side is used to generate a pair of light beams OP₁(λ₂) and OP₂(λ₂) respectively serving as main-channel monitoring beam and backup-channel monitoring beam; and the monitoring beam generating module 210 on the remote side is used to generate a pair of light beams OP₁(λ₄) and OP₂(λ₄) respectively serving as main-channel monitoring beam and backup-channel monitoring beam, and where λ₂≠λ₄≠λ₁λ₃. In practical implementation, for example, the monitoring beam generating module 110, 210 each include a transceiver 111, 211, a WDM (Wavelength Division Multiplexer) unit 112, 212, and a light splitter 113, 213. The transceiver 111, 211 is used to generate a light beam OP(λ₂), OP(λ₄), which is then transferred via the WDM unit 112, 212 to the light splitter 113, 213 where the light beam OP(λ₂), OP(λ₄) is split into two beams respectively used to serve as the above-mentioned main-channel monitoring beam and backup-channel monitoring beam. Beside this embodiment of a single-source splitting method for generating two monitoring beams, the transceiver 111, 211 can also implemented with two light sources and two light receptors for the generating of the main-channel monitoring beam and the backup-channel monitoring beam.

The main-channel multiplexing module 121, 221 are used respectively on the local side and the remote side for injecting the main-channel monitoring beam generated by the monitoring beam generating module 110, 210 in a multiplexing manner into the main channel 31 of the optical transmission line 30. After being injected, the main-channel monitoring beam can be transmitted through the main channel 31 of the optical transmission line 30 to the opposite side. In practical implementation, for example, the main-channel multiplexing module 121, 221 can be implemented with a WDM (Wavelength Division Multiplexer) unit.

The backup-channel multiplexing module 122, 222 are used respectively on the local side and the remote side for injecting the backup-channel monitoring beam generated by the monitoring beam generating module 110, 210 in a multiplexing manner into the backup channel 32 of the optical transmission line 30. After being injected, the backup-channel monitoring beam can be transmitted through the backup channel 32 of the optical transmission line 30 to the opposite side. In practical implementation, for example, the backup-channel multiplexing module 122, 222 can be implemented with a WDM unit.

The main-channel monitoring module 130, 230 are used respectively on the local side and the remote side for monitoring whether the main channel 31 of the optical transmission line 30 can successfully transmit the main-channel monitoring beam that is emitted from the opposite side; and if NOT, capable of generating a first switching enable signal SW1. In practical implementation, for example, the main-channel monitoring module 130, 230 each include an optical coupler 131, 231, an optical filter 132, 232, and a photo diode (PD) 133, 233. The optical coupler 131, 231 is connected to the main channel 31 of the optical transmission line 30, and which is capable of intercepting the main-channel monitoring beam in the main channel 31 and transferring the intercepted beam through the optical filter 132, 232 to the photo diode (PD) 133, 233. The local-side optical filter 132 has a λ₁/λ₂ light filtering function that can filer out light beams of the wavelengths λ₁ and λ₂, whereas the remote-side optical filter 232 has a λ₃/λ₄ light filtering function that can filer out light beams of the wavelengths λ₃ and λ₄. The purpose of the optical filter 132, 232 is to prevent undesired reflections of light beams from the main channel 31 of the optical transmission line 30 due to a breakup of the optical transmission line 30. If these undesired reflections of light beams reach the photo diode (PD) 133, 233, faulty switching control signal SW1 would be generated that would cause a faulty switching action by the local switching control unit 100 and the remote switching control unit 200. The filtered light beams will be sensed by the photo diode (PD) 133, 233, causing the generation of an opto-electrical current from the photo diode (PD) 133, 233. In actual implementation, for example, when the photo diode (PD) 133, 233 produces an opto-electrical current, it represents SW1=1; and whereas if no opto-electrical current is produced, it represents SW1=0.

The backup-channel monitoring module 140, 240 are used respectively on the local side and the remote side for monitoring whether the backup channel 32 of the optical transmission line 30 can successfully transmit the backup-channel monitoring beam that is emitted from the opposite side; and if NOT, capable of generating a second switching enable signal SW2. In practical implementation, for example, the backup-channel monitoring module 140, 240 each include an optical coupler 141, 241, an optical filter 142, 242, and a photo diode (PD) 143, 243. The optical coupler 141, 241 is connected to the backup channel 32 of the optical transmission line 30, and which is capable of intercepting the backup-channel monitoring beam in the backup channel 32 and transferring the intercepted beam through the optical filter 142, 242 to the photo diode (PD) 143, 243. The local-side optical filter 142 has a λ₁/λ₂ light filtering function that can filer out light beams of the wavelengths λ₁ and λ₂, whereas the remote-side optical filter 242 has a λ₃/λ₄ light filtering function that can filer out light beams of the wavelengths λ₃ and λ₄. The purpose of the optical filter 142, 242 is to prevent undesired reflections of light beams from the backup channel 32 of the optical transmission line 30 due to a breakup of the optical transmission line 30. If these undesired reflections of light beams reach the photo diode (PD) 143, 243, faulty switching control signal SW2 would be generated that would cause a faulty switching action by the local switching control unit 100 and the remote switching control unit 200. The filtered light beams will be sensed by the photo diode (PD) 143, 243, causing the generation of an opto-electrical current from the photo diode (PD) 143, 243. In actual implementation, for example, when the photo diode (PD) 143, 243 produces an opto-electrical current, it represents SW2=1; and whereas if no opto-electrical current is produced, it represents SW2=0.

The switching module 150, 250 are used respectively on the local side and the remote side for providing a switching function to the optical transmission line 30, and which are initially set to connect the local optical data processing unit 10 and the remote optical data processing unit 20 to the main channel 31 of the optical transmission line 30; and during actual operation, capable of responding to the first switching enable signal SW1 from the main-channel monitoring module 130 and the second switching enable signal SW2 from the backup-channel monitoring module 140 by switching the connection to the backup channel 32. In actual implementation, for example, the switching module 150, 250 are set to be activated to perform the switching action in response to the condition of (SW1, SW2)=(0, 1), i.e., the condition of a failure to the main channel 31 and a normal condition on the backup channel 32.

In addition, the local switching control unit 100 and the remote switching control unit 200 can each optionally further include an optical filter 160, 260 at the front end. The local-side optical filter 160 has a λ₄ light filtering function that can filer out light beams of the wavelength λ₄ (i.e., the main-channel monitoring beam and the backup-channel monitoring beam from the remote side); whereas the remote-side optical filter 260 has a λ² light filtering function that can filer out light beams of the wavelength λ₂ (i.e., the main-channel monitoring beam and the backup-channel monitoring beam from the local side). However, if the local optical data processing unit 10 and the remote optical data processing unit 20 are internally installed with filtering means that allows beams of wavelengths λ₁ and λ₃ to pass therethrough, the installation of the optical filter 160, 260 is unnecessary.

The following is a detailed description of a practical application example of the optical network backup channel switching control device according to the invention 40 during actual operation.

Referring to FIG. 2A and FIG. 2B, when the optical network is started, the switching module 150, 250 are initially set to connect the local optical data processing unit 10 and the remote optical data processing unit 20 to the main channel 31 of the optical transmission line 30, such that the local optical data processing unit 10 and the remote optical data processing unit 20 can transmit their signal beams OP(λ₁) and OP(λ₃) through the main channel 31. At the same time, the local-side monitoring beam generating module 110 is activated to generate a main-channel monitoring beam OP₁(λ₂) and a backup-channel monitoring beam OP₂(λ₂), which are then injected respectively by the main-channel multiplexing module 121 and the backup-channel multiplexing module 122 into the main channel 31 and the backup channel 32 of the optical transmission line 30. In a similar manner, the remote-side monitoring beam generating module 210 is activated to generate a main-channel monitoring beam OP₁(λ₄) and a backup-channel monitoring beam OP₂(λ₄), which are then injected respectively by the main-channel multiplexing module 221 and the backup-channel multiplexing module 222 into the main channel 31 and the backup channel 32 of the optical transmission line 30.

Under a normal operating condition of the main channel 31, the photo diode (PD) 133, 233 on the main-channel monitoring module 130, 230 will sense the main-channel monitoring beams OP₁(λ₄) and OP₁(λ₂), thereby causing SW1=1. Under the condition of SW1=1, the switching module 150, 250 will maintain their initially-set switching state, i.e., connecting to the main channel 31.

In the event of a failure to the main channel 31, such as due to breakup or fracture, both the photo diode (PD) 133, 233 on the local side and the remote side in the main-channel monitoring module 130, 230 will no longer sense the main-channel monitoring beams OP₁(λ₄) and OP₁(λ₂), thereby causing SW1=0. At the same time, if the backup channel 32 is in good condition, both the photo diode (PD) 143, 243 on the local side and the remote side in the backup-channel monitoring module 140, 240 will respectively sense the backup-channel monitoring beams OP₂(λ₄) and OP₂(λ₂), thereby causing SW2=1. Under the condition of (SW1, SW2)=(0, 1), the switching module 150, 250 will be both activated at the same time to switch the connection to the backup channel 32, allowing the local optical data processing unit 10 and the remote optical data processing unit 20 to transmit their signal beams OP(λ₁) and OP(λ₃) through the backup channel 32.

In conclusion, the invention provides an optical network backup channel switching control device which is designed for use with an optical network for providing the optical network with a backup channel switching control function, and which is characterized by the capability of generating a main-channel monitoring beam and a backup-channel monitoring beam both on the local side and the remote side, where the main-channel monitoring beam is detected on the opposite side to determine whether the main channel is in good condition, and if a failure occurs to the main channel, the backup-channel monitoring beam is detected to determine whether the backup channel is in good condition. If the backup channel is in good condition, a switching action is then performed to switch the connection to the backup channel. This feature allows the optical network to have a higher level of reliability in operation. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An optical network backup channel switching control device for use with an optical network of the type having a local optical data processing unit, a remote optical data processing unit, and an optical transmission line, where the optical transmission line is interconnected between the local optical data processing unit and the remote optical data processing unit and includes a main channel and a backup channel;
the optical network backup channel switching control device comprising:
a local switching control unit for interconnecting the local optical data processing unit with the optical transmission line; and
a remote switching control unit for interconnecting the remote optical data processing unit with the optical transmission line;
and wherein
the local switching control unit and the remote switching control unit each includes:
a monitoring beam generating module, which is capable of generating a main-channel monitoring beam and a backup-channel monitoring beam;
a main-channel multiplexing module, which is capable of injecting the main-channel monitoring beam generated by the monitoring beam generating module in a multiplexing manner into the main channel of the optical transmission line for transmitting the main-channel monitoring beam to opposite side;
a backup-channel multiplexing module, which is capable of injecting the backup-channel monitoring beam generated by the monitoring beam generating module in a multiplexing manner into the backup channel of the optical transmission line for transmitting the backup-channel monitoring beam to the opposite side;
a main-channel monitoring module, which is capable of monitoring whether the main channel of the optical transmission line can successfully transmit the main-channel monitoring beam from the opposite side; and if NOT, capable of generating a first switching enable signal;
a backup-channel monitoring module, which is capable of monitoring whether the backup channel of the optical transmission line can successfully transmit the backup-channel monitoring beam from the opposite side; and if NOT, capable of generating a second switching enable signal; and
a switching module, which is initially set to be connected to the main channel of the optical transmission line; and during actual operation, capable of responding to the first switching enable signal from the main-channel monitoring module and the second switching enable signal from the backup-channel monitoring module by switching the connection to the backup channel of the optical transmission line.

2. The optical network backup channel switching control device of claim 1, wherein the optical network is a single-line two-way transmission type of optical network.

3. The optical network backup channel switching control device of claim 1, wherein the monitoring beam generating module utilizes a single-source splitting method for generating the main-channel monitoring beam and the backup-channel monitoring beam from a single light source.

4. The optical network backup channel switching control device of claim 1, wherein the main-channel multiplexing module and the backup-channel multiplexing module are each a WDM (Wavelength Division Multiplexer) unit.

5. The optical network backup channel switching control device of claim 1, wherein the main-channel monitoring module includes:
an optical coupler, which is connected to the main channel of the optical transmission line for intercepting the main-channel monitoring beam in the main channel; and
a photo diode, which is capable of sensing the intercepted beam by the optical coupler and responsively generating an opto-electrical signal representing the first switching enable signal.

6. The optical network backup channel switching control device of claim 5, wherein the main-channel monitoring module further includes:
an optical filter, which is coupled between the optical coupler and the photo diode, for filtering out reflections of the light beams transmitting through the main channel of the optical transmission line due to a breakup in the main channel.

7. The optical network backup channel switching control device of claim 1, wherein the backup-channel monitoring module includes:
an optical coupler, which is connected to the backup channel of the optical transmission line for intercepting the backup-channel monitoring beam in the backup channel; and
a photo diode, which is capable of sensing the intercepted beam by the optical coupler and responsively generating an opto-electrical signal representing the second switching enable signal.

8. The optical network backup channel switching control device of claim 7, wherein the backup-channel monitoring module further includes:
an optical filter, which is coupled between the optical coupler and the photo diode, for filtering out reflections of the light beams transmitting through the backup channel of the optical transmission line due to a breakup in the backup channel.

9. The optical network backup channel switching control device of claim 1, wherein the local switching control unit and the remote switching control unit each further include:
an optical filter, which is installed at the front end of the switching module for filtering out the main-channel monitoring beam and the backup-channel monitoring beam from the opposite side.
